(19) United States
(12) Patent Application Publication
(10) Pub. No.: US 2016/0104247 A1
(43) Pub. Date: Apr. 14, 2016

(54) CAPITAL ACCUMULATION PLAN (CAP) RETIREMENT SYSTEM

(71) Applicant: Gary P. DiCresce, Saratoga Springs, NY (US)

(72) Inventor: Gary P. DiCresce, Saratoga Springs, NY (US)

(21) Appl. No.: 14/512,767

(22) Filed: Oct. 13, 2014

(51) Int. Cl. G06Q 40/08; G06Q 10/10

(52) U.S. Cl. CPC G06Q 40/08; G06Q 10/1057

(57) ABSTRACT

Approaches presented herein providing a capital accumulation plan (CAP) retirement plan implemented in a non-profit institution (e.g., a non-profit hospital). One approach includes identifying a set of members of the non-profit institution, extracting a deferred compensation amount intended for each of the set of members, using a first portion of the deferred compensation amount intended for each of the set of members to purchase a term life universal life insurance policy for each of the set of members, routing a second portion of the deferred compensation amount intended for each of the set of executives members to one or more interest bearing investment vehicles, and disbursing future benefits to the set of members, the disbursement taken from the second portion of the deferred compensation invested into the one or more interest bearing investment vehicles.

### BACKGROUND

1. Field of the Invention

This invention relates generally to capital appreciation retirement plans and, more specifically, to a capital appreciation plan (CAP) retirement system that incorporates within it a life insurance policy for a set of members of a non-profit institution.

2. Description of the Related Art

A number of uses for life insurance products have emerged in recent years to fulfill a dual investment and future liability funding purpose. One prominent example is Corporate Owned Life Insurance (COLI) plans, in which a corporation purchases life insurance on its employees. The corporation pays all premiums for the life insurance and receives the bulk of the death benefits. The death benefit proceeds received by the corporation are tax free. Because of the tax free nature of the death benefits, the rate of return earned on the premiums paid to purchase the insurance is typically attractive to the corporation on an after-tax basis. The returns from COLI (and related plans, such as Bank Owned Life Insurance or BOLI) are often used to fund future compensation and benefit liabilities of the corporation. In many cases, COLI returns are used to fund so called nonqualified retirement plans, which provide pension, health, and other retirement benefits to former employees of the corporation. These benefits are more easily defined, funded and administered using a COLI plan as compared to traditional methods of funding qualified benefit programs.

Even more recently, nonprofit institutions such as hospitals, churches, foundations, and charities have become interested in using the unique features of life insurance to fund future liabilities and operations. In developing planned giving programs, such nonprofit institutions, also referred to as charitable organizations, have employed life insurance policies and annuity contracts. For example, it is a common practice for nonprofit institutions to solicit the owner of a life insurance policy to name the nonprofit entity as the policy's beneficiary. The owner pays the premiums on the policy and, at the time of the insured's death the nonprofit institution receives the death benefit. Another common practice involving life insurance policies is for the owner of the policy to donate both the ownership and beneficial interest in the policy to the charity along with a pledge to remit future premium payments to the charity so that the policy can be maintained in force.

As is relatively well known, a life insurance policy typically has three distinct categories of parties, which have an interest in the contract: the owners, the insured, and the beneficiaries. The owner is the party, which is responsible for maintaining the policy in force by remitting premium payments to the insurance company. The insured is the person upon whose death the policy death benefit is paid. The beneficiary is the party, which receives the death benefit upon the death of the insured. A holder of a life insurance policy may refer to, for example, a purchaser or an owner of the contract, or a beneficiary under the policy, or a combination of two or more of the above. Under a typical life insurance policy, the insured individual is the holder of the policy, because (s)he has purchased the policy, is the policy owner and beneficiary. However, there is no requirement that the owner, insured, or beneficiary be the same person, as described in further detail below. The holder of the policy may then just refer to the owner, or the entity who purchased the policy. For example, the owner of a policy may legally donate the policy to a charity which insures the life of his wife and which names his son as beneficiary. In making the donation, the donor will typically name the charity as beneficiary and then transfer ownership status of the policy. However, in order for the donation to have enduring value, the policy must be kept in force. The donor and former owner, therefore, must make a commitment for paying future premium payments. Most states have adopted laws under which charities may own, purchase, or be named beneficiary of life insurance policies on consenting individuals. These laws directly confer an insurable interest upon the charity and allow the elimination of the administratively burdensome step of requiring the donor to first purchase a new policy and then donate it to the charity.

Religious/Charitable institutions have developed programs known as ROLI (for Religious Owned Life Insurance), FOLI (for Foundation Owned Life Insurance), and CHOLI (for Charity Owned Life Insurance). These programs have involved the enlisting of past or future donors or benefactors for the purpose of purchasing insurance on a pool of such donors or benefactors. The nonprofit entity usually borrows the money to pay for the insurance premiums from a bank (or possibly the insurance company itself), and receives death benefits when its donors die. The death benefits are then used to repay the loans from the bank or the insurance company. The balance of the death benefits, if any, is used to fund the nonprofit entities' primary objectives, such as finding research, furthering religious programs, or disbursing benefits to the needy.

Some states, however, have additional statutory law that restricts the purchase of a policy in other situations. For example, the New York Insurance Laws, section 3205(b)(2) states that “No person shall procure or cause to be procured, directly or by assignment or otherwise any contract of insurance upon the person of another unless the benefits under such contract are payable to the person insured or his personal representatives, or to a person having, at the time when such contract is made, an insurable interest in the person insured.” Such states have carved out exceptions for nonprofit institutions. For example New York Insurance Laws section 3205(b)(3) provides a safe harbor for nonprofit entities which “procure or cause to be procured, directly or by assignment or otherwise, a contract of life insurance upon the person of another and may designate itself or cause to have itself designated as the beneficiary of such contract.”

### SUMMARY

In general, embodiments described herein provide a capital accumulation plan (CAP) retirement plan implemented in a non-profit institution (e.g., a non-profit hospital). One approach includes identifying a set of (e.g., executives, doctors, etc.) members of the non-profit institution, extracting a deferred compensation amount intended for each of the set of members, using a first portion of the deferred compensation amount intended for each of the set of members to purchase a term life universal life insurance policy for each of the set of members, routing a second portion of the deferred compensation amount intended for each of the set of executives members to one or more interest bearing investment vehicles, and disbursing future benefits to the set of members, the disbursement taken from the second portion of the deferred compensation invested into the one or more interest bearing investment vehicles. This plan falls under 457(f) of the IRS code, so there are no restrictions on the amount of deferrals the executive or physician can make on a pre-tax basis. This approach provides the participant (i.e., executive employee) with tax free retirement benefits paid over 15 years as well as tax tree death benefits and tax free disability benefits. The non-profit institution receives the tax-free death benefit from the insurance policy and only pays out the interest on the death proceeds. The non-profit institution keeps the principal sum of the death benefit and invests it back into the side fund to pay other participants future benefits. Furthermore, this approach creates a cash surplus for the non-profit institution and, based on the incidence of mortality that takes place in the future, the non-profit institution may be able to increase the benefits paid to the participants.

One aspect of the present invention includes a method for providing a capital accumulation plan (CAP) retirement plan implemented in a non-profit institution, the method comprising: identifying, by a computing device, a set of members of the non-profit institution; extracting, by the computing device, a deferred compensation amount intended for each of the set of members; using a first portion of the deferred compensation amount intended for each of the set of members to purchase a term life universal life insurance policy for each of the set of members; routing, by the computing device, a second portion of the deferred compensation amount intended for each of the set of executives members to one or more interest bearing investment vehicles; disbursing, by the computing device, future benefits to the set of members, the disbursement taken from the second portion of the deferred compensation invested into the one or more interest bearing investment vehicles.

Another aspect of the present invention includes a system for providing a capital accumulation plan (CAP) retirement plan implemented in a non-profit institution, comprising: a memory medium comprising program instructions; a bus coupled to the memory medium; and a processor, for executing the program instructions, coupled to a CAP tool via the bus that when executing the program instructions causes the system to: identify a set of members of the non-profit institution; extracting, by the computing device, a deferred compensation amount intended for each of the set of members, the deferred compensation amount being pre-tax compensation; use a first portion of the deferred compensation amount intended for each of the set of members to purchase a term life universal life insurance policy for each of the set of members; route a second portion of the deferred compensation amount intended for each of the set of executives members to one or more interest bearing investment vehicles; disburse future benefits to the set of members, the disbursement taken from the second portion of the deferred compensation invested into the one or more interest bearing investment vehicles.

Yet another aspect of the present invention includes a computer program product for providing a capital accumulation plan (CAP) retirement plan implemented in a non-profit institution, the computer program product comprising a computer readable storage device, and program instructions stored on the computer readable storage device, to: identify a set of members of the non-profit institution; extract a deferred compensation amount intended for each of the set of members, the deferred compensation amount being pre-tax compensation; use a first portion of the deferred compensation amount intended for each of the set of members to purchase a term life universal life insurance policy for each of the set of members; route a second portion of the deferred compensation amount intended for each of the set of executives members to one or more interest bearing investment vehicles; disburse future benefits to the set of members, the disbursement taken from the second portion of the deferred compensation invested into the one or more interest bearing investment vehicles.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments;

FIG. 2 shows a more detailed view of a CAP tool according to illustrative embodiments;

FIG. 3 shows an implementation of the CAP tool according to illustrative embodiments;

FIG. 4 shows an implementation of the CAP tool according to illustrative embodiments;

FIGS. 5A and 5B show an implementation of the CAP tool according to illustrative embodiments;

FIGS. 6A and 6B show an implementation of the CAP tool according to illustrative embodiments; and

FIG. 7 shows an exemplary process flow for structuring a CAP retirement plan according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide a capital accumulation plan (CAP) retirement plan implemented in a non-profit institution (e.g., a non-profit hospital). One approach includes identifying a set of members of the non-profit institution (e.g., automatically based on salary, title, or by voluntary election or selection by a supervisor), extracting a deferred compensation amount intended for each of the set of members (e.g., by withholding a percentage or dollar amount selected by the member), using a first portion of the deferred compensation amount intended for each of the set of members to purchase a term life universal life insurance policy for each of the set of members, routing a second portion of the deferred compensation amount intended for each of the set of executives members to one or more interest bearing investment vehicles (also referred to herein sometimes as the “side fund”), and disbursing future benefits to the set of members, the disbursement taken from the second portion of the deferred compensation invested into the one or more interest bearing investment vehicles, i.e., the side fund. This approach provides the participant (i.e., executive employee) with tax free retirement benefits paid over 15 years as well as tax tree death benefits and tax free disability benefits. The non-profit institution receives the tax-free death benefit from the insurance policy and only pays out the interest on the death proceeds. The non-profit institution keeps the principal sum of the death benefit and invests it back into the side fund to pay other participants future benefits. Furthermore, this approach creates a cash surplus for the non-profit institution and, based on the incidence of mortality that takes place in the future, the non-profit institution may be able to increase the benefits paid to the participants.

It is also noted that this plan falls under current 457(f) of the IRS code, so there are no restrictions on the amount of deferrals the executive or physician can make on a pre-tax basis. A Section 457(f) plan is often termed an “ineligible” nonqualified deferred compensation plan because tax-exempt and governmental employers are permitted to provide compensation in amounts that exceed limitations imposed on 457(b) “eligible” plans. A 457(f) plan is usually established as a way of retaining executives, officers and select groups of highly compensated employees with supplemental retirement benefits.

In addition to providing supplemental compensation, a 457(f) plan provides executives with an opportunity to both reduce taxable income through the deferral of unlimited amounts of compensation, as well as receive distributions after retirement when they are more likely in a lower tax bracket. In some cases, a 457(f) plan is relatively less difficult to establish because there are no requirements regarding coverage, eligibility, participation, vesting, etc. further, these plans can be designed in a variety of ways, depending on the executive's time to retirement, the tax strategy and funding arrangement desired, as well as other features preferred by the institution and the executive. Furthermore, assets are owned by the institution, subject to the claims of their creditors, and invested as determined by the institution and the executive.

The approaches described herein contain numerous advantages over present methods including, but not limited to, the following: 1) the plan pools the executive group together and the executives defer a part of their pre-tax compensation into the general assets of the Hospital; 2) the plan falls under 457(f) of the IRS code, so there are no restrictions on the amount of deferrals the executive or physician can make on a pre-tax basis; 3) the plan provides the Participant with Tax Free Retirement Benefits paid over 15 years as well as Tax Free Death Benefits and Tax Free Disability Benefits; 4) the non-profit institution receives the tax free death benefit from the insurance policy and only pays out the interest on the death proceeds; 5) The non-profit institution keeps the principal sum of the death benefit and invests it back into the side fund to pay other participants future benefits; 6) the plan creates a cash surplus for the Hospital and based on the incidence of mortality that takes place in the future the Hospital may be able to increase the benefits paid to the Participants over and above what is shown below; and 7) all Benefits are paid with plan assets not non-profit institution assets.

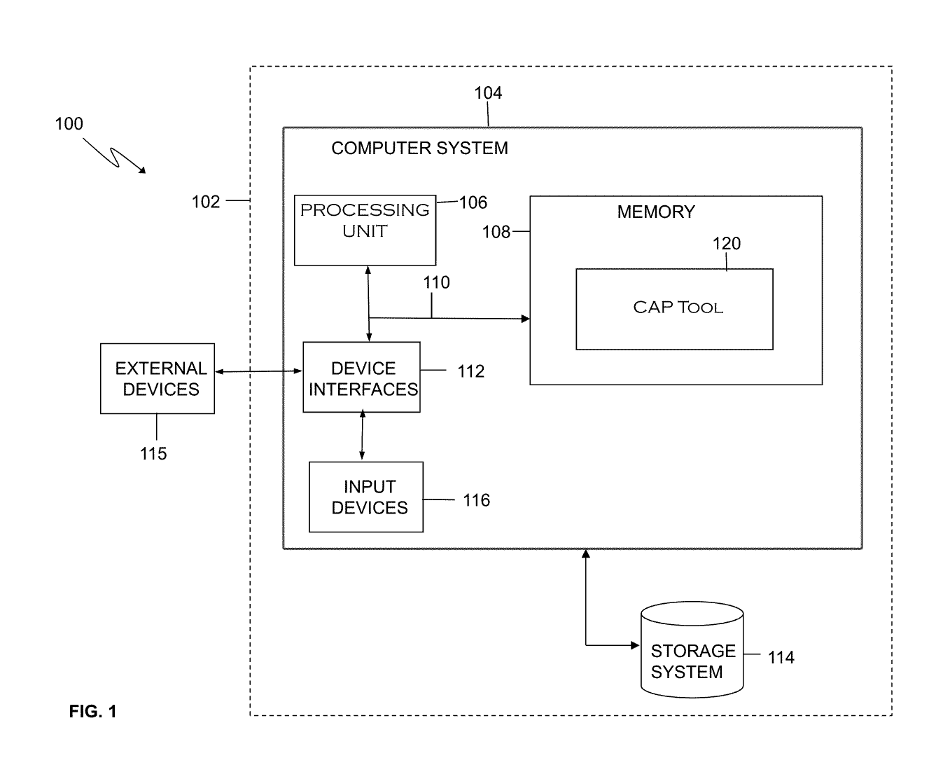

Along these lines, as shown in FIG. 1, a computerized implementation 100 of an exemplary embodiment for providing a capital accumulation plan (CAP) retirement plan implemented in a non-profit institution (e.g., a non-profit hospital) will be shown and described. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), a cloud-computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing a CAP retirement plan implemented in a non-profit institution (e.g., a non-profit hospital). It should be understood that any other computers implemented under the present invention may have different components/software, but can perform similar functions. As shown, computer system 104 includes a processing unit 106 capable of communicating with a capital appreciation plan (CAP) tool 120 stored in memory unit 108, a bus 110, and device interfaces 112. In general, CAP tool 120 can be implemented as program/utility on computer system 104 and can enable the functions recited herein. As further shown, CAP tool 120 (in one embodiment) comprises a rules and/or computational engine that processes a set (at least one) of rules/logic.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes signals representing inputs and outputs between external devices 115, input devices 116, and IDE 118. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating CAP tool 120, which is stored in memory 108 and/or storage system 114. While executing computer program code, processing unit 106 can read and/or write data to/from memory 108, storage system 114, and CAP tool 120.

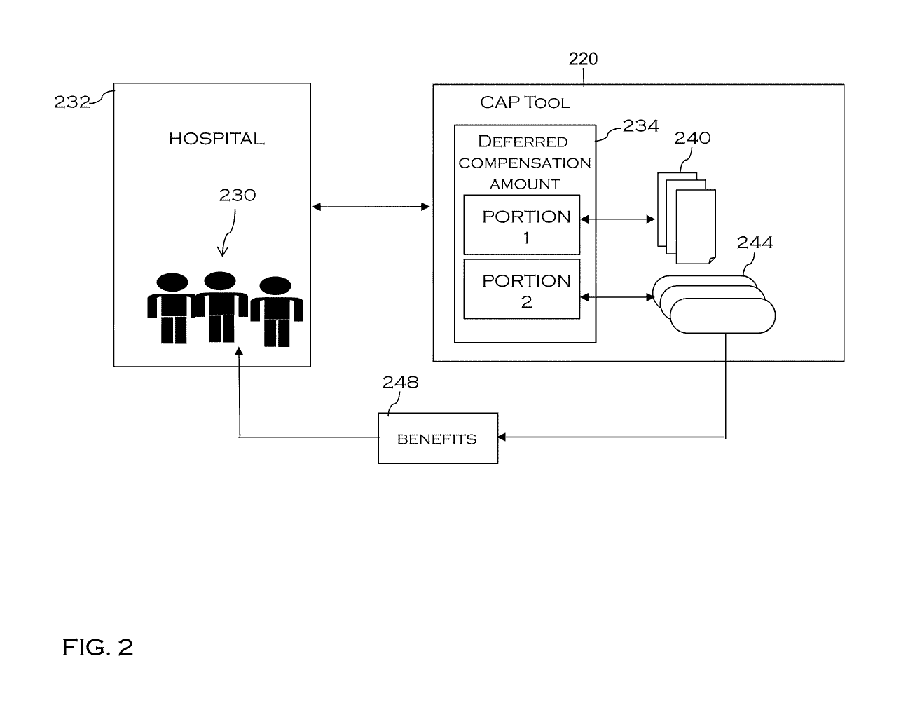

Referring now to FIG. 2, the structure and operation of CAP tool 220 will be described in greater detail. In an exemplary embodiment, CAP tool 220 identifies a set of members 230 of a non-profit institution (e.g., a hospital), extracts a deferred compensation amount 234 intended for each of the set of members 230, deferred compensation amount 234 being pre-tax compensation. CAP tool 220 then uses a first portion of deferred compensation amount 234 intended for each of the set of members to purchase a term life universal life insurance policy 240 for each executive member 230, and routes a second portion of deferred compensation amount 234 intended for each of the set of executives members to one or more interest bearing investment vehicles 244 (e.g., certificates of deposit (CDs) or bonds, stocks, options, futures, annuities, collectibles (art or coins, for example), precious metals, mutual funds, exchange-traded funds (ETFs), and the like.) After a certain amount of time, CAP tool 220 disburses future benefits 248 (e.g., a tax free retirement benefit, a tax free death benefit, and a tax free disability benefit) to members 230, wherein the disbursement is taken from the second portion of deferred compensation 234 invested into the one or more interest bearing investment vehicles 244.

To further demonstrate the invention, consider the following examples/scenarios. This case describes benefits Per $100,000 of Salary @ 1 unit.
If the Executive dies before age 65 the Executive's beneficiary will receive a survivorship benefit paid over 15 years.
A. SURVIVORSHIP BENEFIT—IN THE EVENT YOU DIE BEFORE ELECTING YOUR RETIREMENT BENEFITS
   1. Annual “Tax Free” Payment $18,000
   2. Total “Tax Free” Payments to Participant over 15 years $270,000
At time of enrollment, the Executive has the choice to receive retirement benefits or opt for increased survivorship benefits for the Executive's heirs if they die after age 65.
B. RETIREMENT BENEFITS—AT AGE 65 for 15 YEARS
   1. Annual “Tax Free” Payment $18,000
   2. Total “Tax Free” Payments to Participant over 15 years $270,000 or
C. INCREASED SURVIVORSHIP BENEFITS—AFTER AGE 65 for 15 YEARS
   1. Annual “Tax Free” Payment $22,500
   2. Total “Tax Free” Payments to Beneficiary over 15 years $337,500
All plans have a Disability Benefit included
D. DISABILITY BENEFITS
   PAID AT AGE 65
   100% VESTED IN THE EVENT OF PERMANENT DISABILITY
   IN LIEU OF DEATH AND RETIREMENT BENEFITS
   1. Annual “Tax Free” Payment $18,000
   2. Total “Tax Free” Payments to Participant over 15 years $270,000

In yet another example, consider the following non-limiting scenario in which the tax free surplus created by the investment vehicles is provided to the hospital after paying all benefits and bonuses to the participants (e.g., executives) and earnings at 4% on the asset account. Here, it is assumed no mortality until Age 65 for the 456 participants age 60 and under with 50% of the after tax deferrals refunded. Along these lines, it is assumed that 47 Participants age 61-65 will start dying at age 70, 50% of the 15 Participants between ages 66-70 will die at 85 and 50% will die at age 87,50% of the 11 Participants between ages 71-75 will die at age 87 and 50% will die at age 89 and the 4 Participants age 76-80 will die at 90.

Assume 533 Participants with 1,954.25 Units

| | | | | Total Gain |
|---|---|---|---|---|
| | | | | to Hospital |
| | Percent | | | After Re- |
| | of | Total Gain to | Hospital's | ceiving Their |
| | Partic- | Hospital After | 20% Contri- | Contribu- |
| | ipants | All Benefits | bution at | tion @ 4.00% |
| Year | Alive | and Bonuses | 4.00% | Col. 3-4 |
| 1 | 100% | 21,315,586 | 5,388,486 | 15,927,100 |
| 5 | 100% | 48,726,492 | 29,185,777 | 19,540,715 |
| 10 | 97.52% | 115,140,488 | 60,782,573 | 54,357,914 |
| 15 | 92.17% | 147,497,715 | 87.029,186 | 60,468,528 |
| 20 | 82.08% | 216,025,603 | 110,637,255 | 105,388,348 |
| 25 | 71.51% | 258,505,641 | 136,814,820 | 121,690,821 |
| 30 | 58.60% | 326,969,933 | 166,945,987 | 160,023,945 |
| 40 | 33.27% | 633,721,675 | 247,135,727 | 386,585,947 |
| 50 | 17.02% | 1,059,400,003 | 365,821,248 | 693,578,755 |

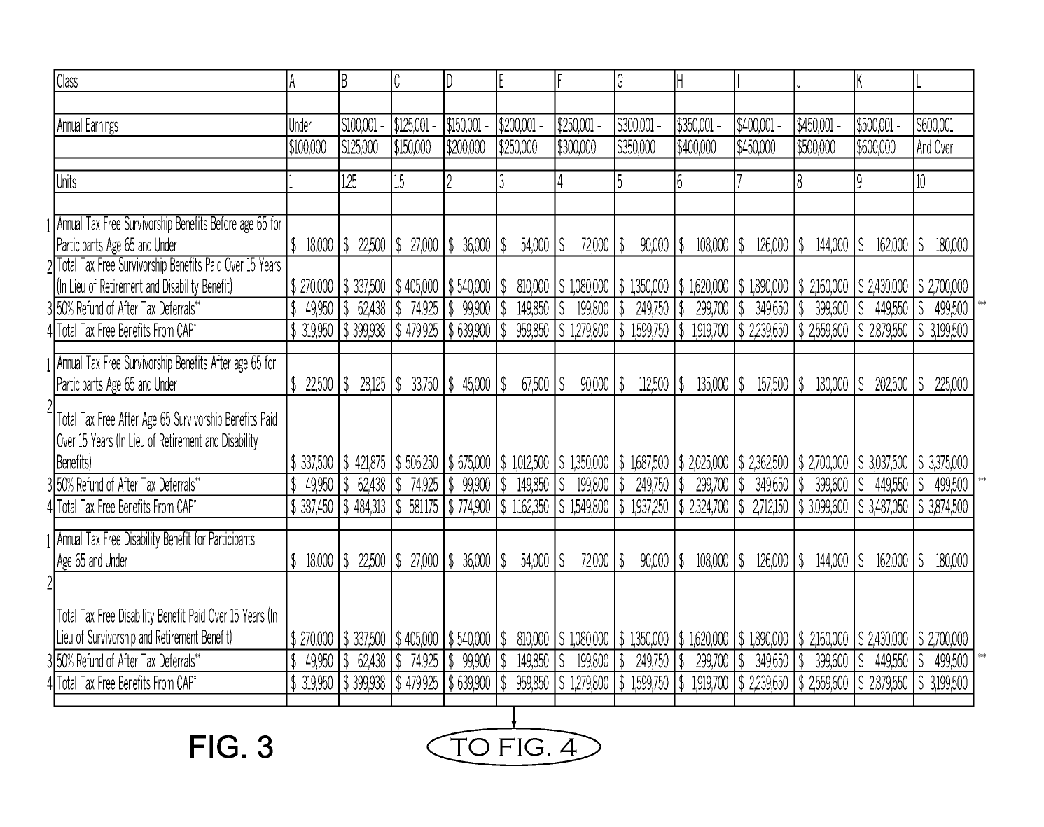

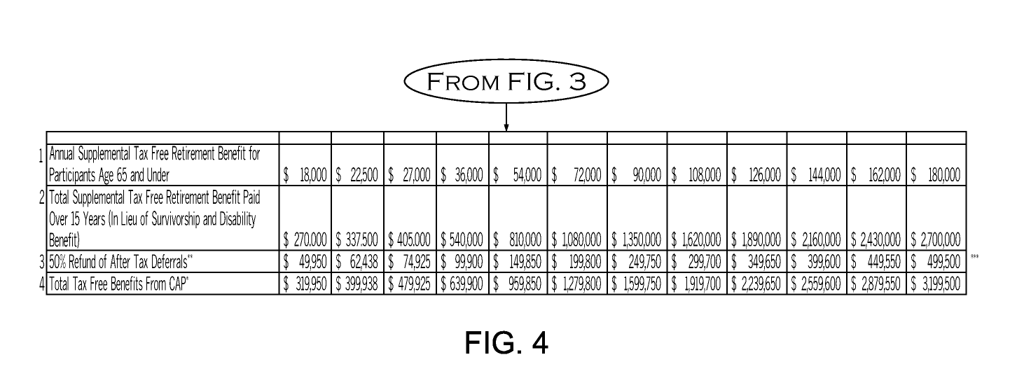

Turning now to FIGS. 3-4, the benefit of using CAP tool 120 at various income levels for participants age 60 and under payable for 15 years is demonstrated. In this example, 50%/100% is refunded of participant's after-tax deferrals. As the salary of the physician and executives increases, retirement benefits, survivorship benefits, and disability benefits increase as shown. Furthermore, it is noted that the example shown in FIGS. 3-4 use the age group 46-50 for the 50%/100% refund of the after-tax deferrals. If an executive is older, the refund will be higher. If the executive is younger the refund will be lower.

As further shown in FIGS. 3-4, it is noted that the numbers shown in rows labeled with ‘3’ are the 50% refund they would be doubled to provide 100% refund of the participant's age 60 and under after tax deferral with no mortality for 10 years. See the Tax Free Surplus to the Hospital shown above with no mortality for 10 years and 100% refund and/or 50% refund.

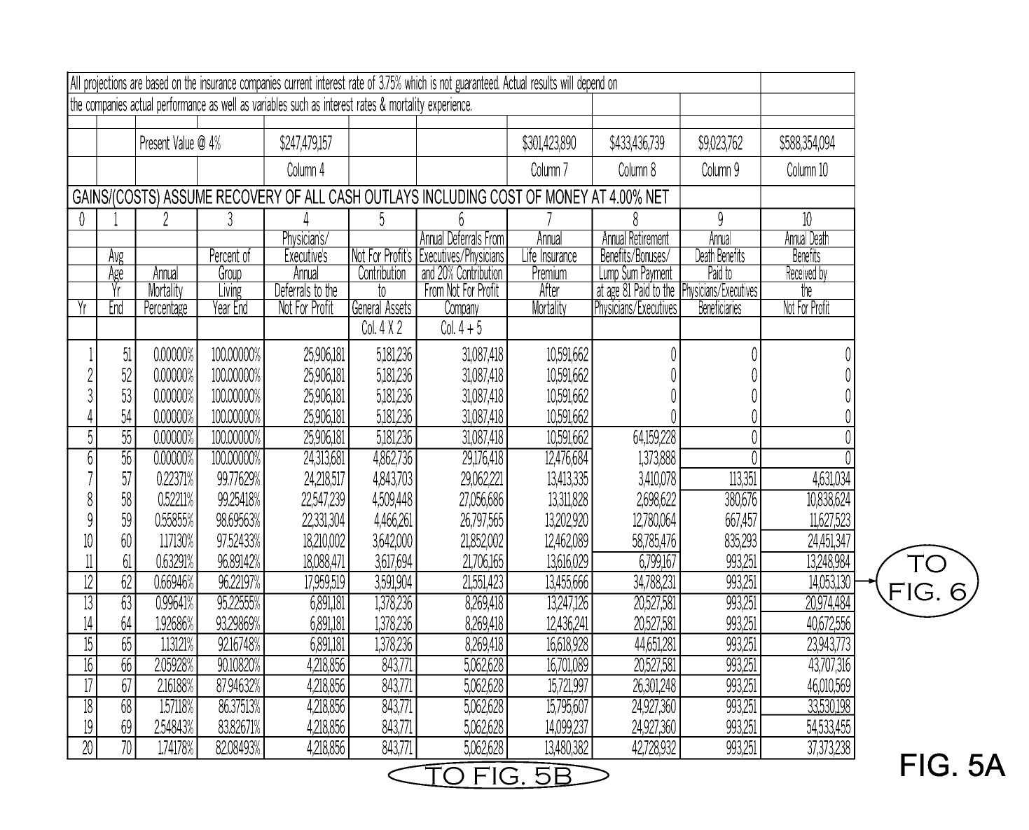

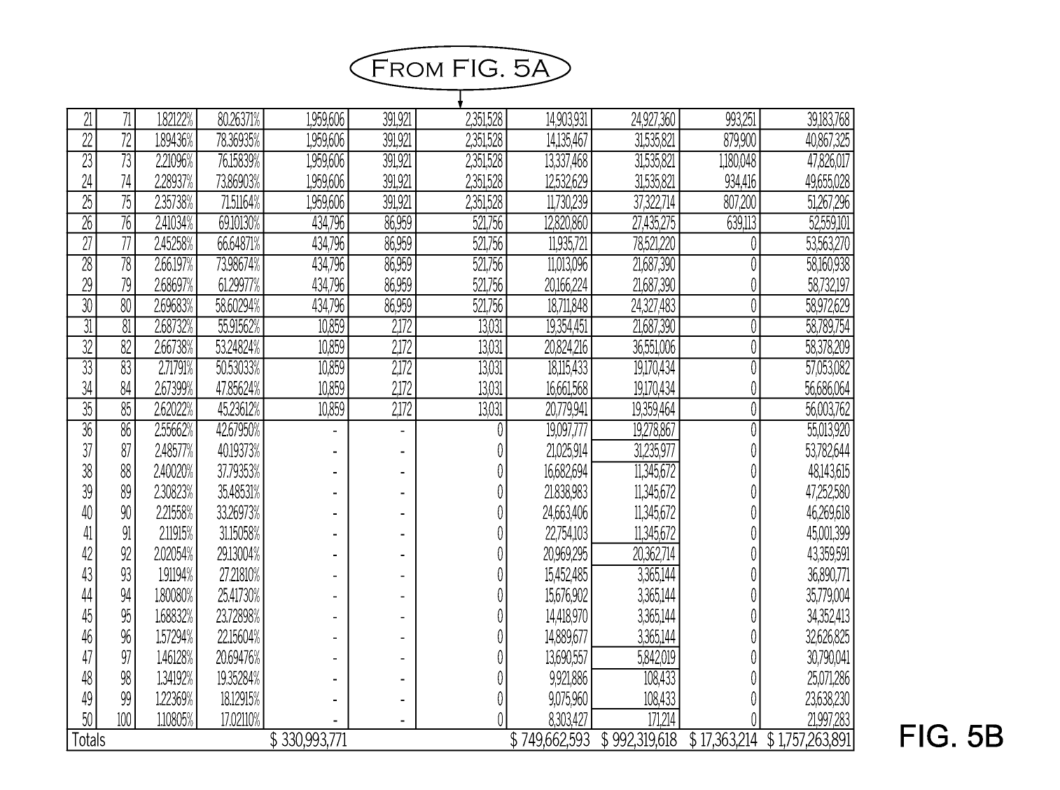

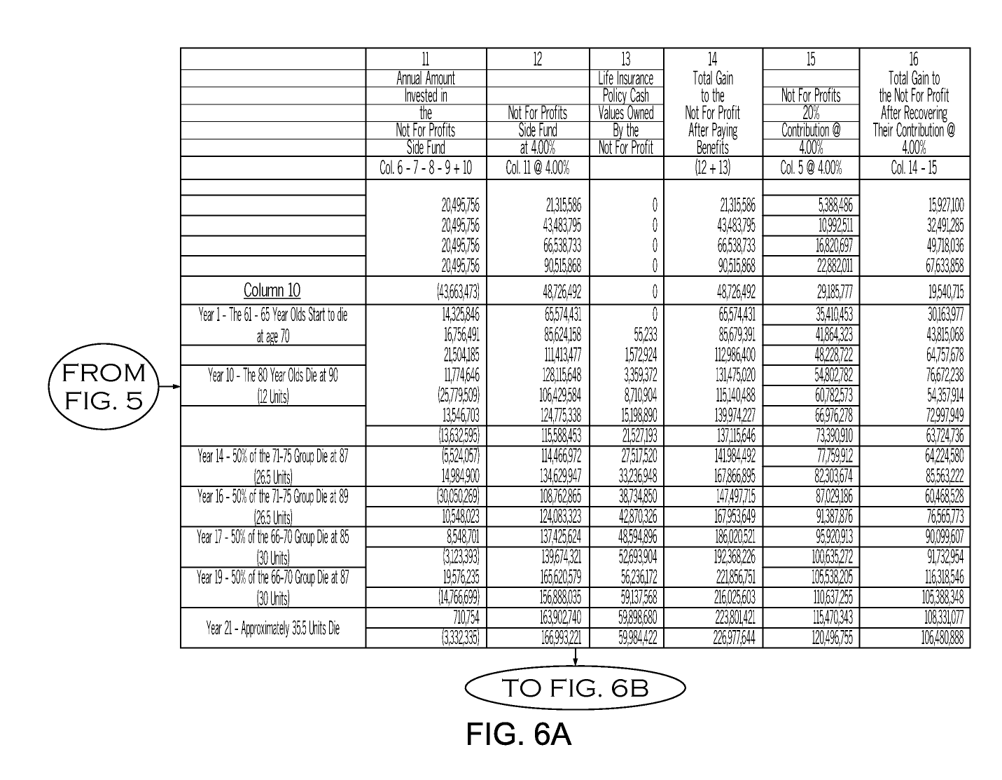

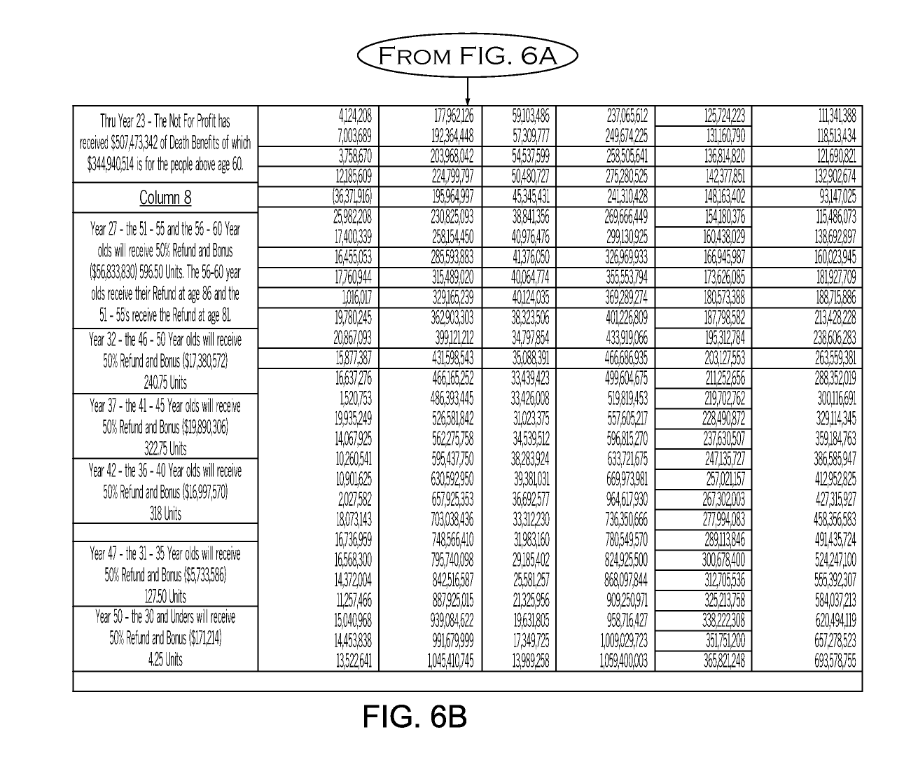

Turning now to FIGS. 5A, 5B, 6A, and 6B, a non-limiting profit/loss projection is shown and described in greater detail. It will be appreciated that the following non-limiting assumptions/parameters are assumed:
Total Participants: 533 (456 participants age 60 and under and 77 participants above age 60)*
Total Units: 1,954.25 (1,633.25 units age 60 and under and 321 units above age 60)*
Weighted Average Age: 50
Age Eligible for Retirement:
   65 (for people entering the Plan at age 55 and under)
   70 (for people entering the Plan at ages 56-60)
   For people above 60, they will begin receiving retirement benefits after they make all of their deferrals
Net Return on Investments: 4.00%
Corporate Tax Bracket: 0.0%
Mortality Assumption:
   No mortality until age 65 for participants age 60 and under, then 100% of the 2001 Commissioners Standard Ordinary Mortality Table.
   Participants age 61-65 begin dying at age 70.
   Participants age 66-70: 50% die at age 85 and 50% die at age 87.
   Participants 71-75: 50% die at 87 and 50% die at 89.
   Participants age 76-80 die at 90.
Insurance:
   Average Initial Insurance Face Amount per Unit: $1,041,476
   Average Amount of Insurance per Person: $3,939,961
   Total Initial Insurance Face amount for 1,954.25 units: $2,035,304,307
Benefits per Unit:
   Annual Survivorship Benefit to Beneficiary for 15 yrs before age 65: $18,000 Tax Free
   Annual Survivorship Benefit to Beneficiary for 15 yrs after age 65: $22,500 Tax Free
   Annual Disability Payments for 15 yrs in lieu of Survivorship Benefit and Retirement Benefit: $18,000 Tax Free
   Annual Retirement Payments for 15 yrs in lieu of Survivorship Benefit and Disability Benefit: $18,000 Tax Free

In this example, there are 533 Participants, wherein 3 participants with 4.25 units age 30 and under, 56 participants age 31-35 with 127.50 units, 101 participants age 36-40 with 318 units, 93 participants age 41-45 with 322.75 units, 66 participants age 46-50 with 240.75 units, 68 participants age 51-55 with 291.75 units, 69 participants age 56-60 with 328.25 units, 47 participants age 61-65 with 196 units, 15 participants age 66-70 with 60 units, 11 participants age 71-75 with 53 units, 4 participants age 76-80 with 12 units.

To determine the $64,159,228 in year 5 we use a 50 year old as an example. We take the $18,000 retirement payment that is payable for 15 years and present value this number back to age 65 at 5.00%. The result is $186,834. Then we present value this number back 10 years to the Participant's current age 55, the result is $114,700. We also need to present value back the 50% refund at 5.00%. The 50 year old will receive a refund of $49,950 at age 81. The present value of the $49,950 back 26 years to the Participant's age 55 is $14,048. The total present value of the retirement benefit and the 100% refund at 5.00% is $128,748 ($114,700+$14,048). Then we determine the vesting percentage for the 50 year old by taking 100% and dividing it by 15 years, the number of years they will defer for, to equal 6.667% per year. Next we multiply 6.667% by 5 years, which equals 33.33%. This is the percentage of benefits that the participant will vest in 5 years. Then we multiply $128,748 by 33.33%. This equals $42,912, which is the vested benefit after 5 years. The participant will pay tax on this benefit equal to $17,165 in a 40% tax bracket. In order to pay the taxes the Hospital will bonus the participant $28,608 ($17,165 divided by 0.6). The $28,608×1,954.25 units equals $55,907,184. (The older people vest sooner that's why there is a discrepancy between the $64,159,228 and the $55,907,184)

As shown in FIGS. 5A, 5B, 6A, and 6B, in Year 5, 533 Participants with 1,954.25 Units will receive a bonus to pay the taxes due because they vest in a portion of their benefits. It will be appreciated that this vesting occurs in year 5 (or sooner), in order to comply with the eligibility requirements of section 457(f) of the IRS code. This money coming out to pay the bonus comes from the side fund. It will show up as a book entry only, as needed for tax purposes, but not as a cash contribution. In this way, the plan costs the Hospital nothing.

In Year 6, 15 Participants with 65 units who are 71 and older begin receiving their Retirement Benefits. In Year 7, 15 Participants with 60 units age 66-70 receive a bonus for the taxes due because they vest in the balance of their benefits. Also deaths begin to occur in the 61-65 group at age 70. In Year 8, 15 Participants with 60 units age 66-70 begin receiving Retirement Benefits. In Year 9, 47 Participants with 196 units age 61-65 receive a bonus for the taxes due because they vest in the balance of their benefits. In Year 10, 456 Participants with 1,633.25 units (the Participants under age 60) will receive a bonus to pay the taxes due because they vest in a portion of their benefits. In Year 10, 47 Participants with 196 units (the 61-65 group) will begin receiving their Retirement Benefits. In Year 12, Retirement Benefits Begin for the 51-55 Year olds and the 56-60 Year olds. Retirement Benefits begin at age 65 for the 51-55 Year olds and at age 70 for the 56-60 Year olds. In Year 15, the participants age 50 and under will receive a bonus to pay the taxes due because they vest in a portion of their benefits. In Year 17, Retirement Benefits Begin at age 65 for the 46-50 Year olds. In Year 20, the participants age 45 and under will receive a bonus to pay the taxes due because they vest in a portion of their benefits. In Year 22, Retirement Benefits Begin at age 65 for the 41-45 Year olds. In Year 25, the participants age 40 and under will receive a bonus to pay the taxes due because they vest in a portion of their benefits. In Year 27, Retirement Benefits Begin at age 65 for the 36-40 Year olds. In Year 30, the participants age 35 and under will receive a bonus to pay the taxes due because they vest in a portion of their benefits. In Year 32, Retirement Benefits Begin at age 65 for the 31-35 Year olds. In Year 35, the participants age 30 and under will receive a bonus to pay the taxes due because they vest in a portion of their benefits and they will begin receiving their Retirement Benefits.

It can be appreciated that the approaches disclosed herein can be used within a computer system to provide a capital accumulation plan (CAP) retirement plan implemented in a non-profit institution. In this case, as shown in FIG. 1, CAP tool 120 can be provided, and one or more systems for performing the processes described in the invention can be obtained and deployed to computer infrastructure 102. To this extent, the deployment can comprise one or more of (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary computer system 104 (FIG. 1) may be described in the general context of computer-executable instructions, such as program modules, being executed by a computer. Generally, program modules include routines, programs, people, components, logic, data structures, and so on, which perform particular tasks or implement particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

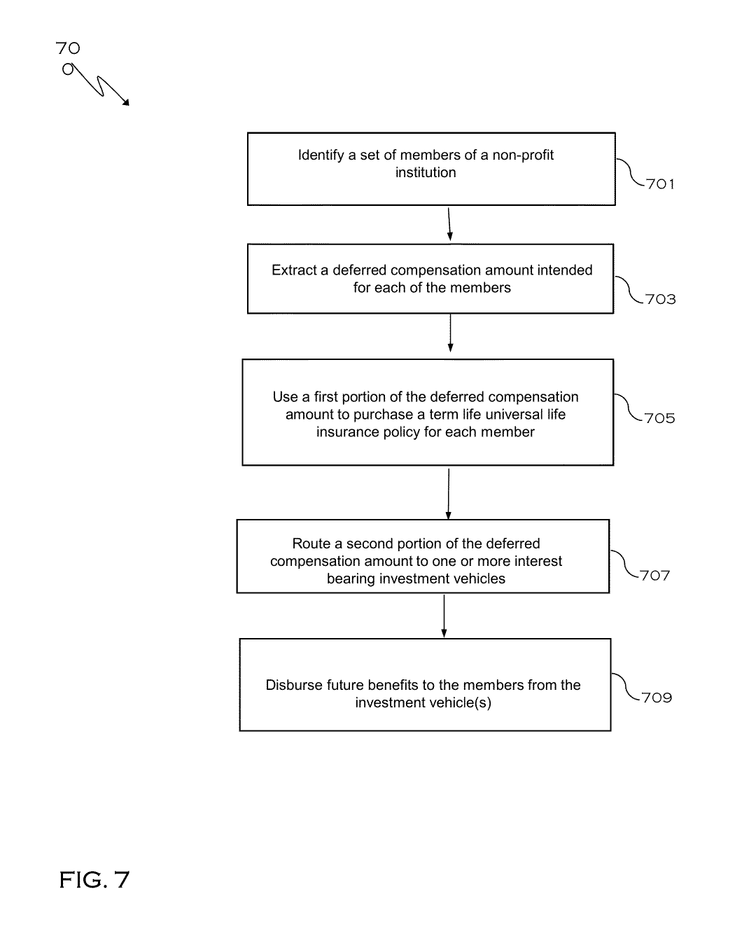

As depicted in FIG. 7, a system (e.g., computer system 104) carries out the methodologies disclosed herein. Shown is a process flow 700 for structuring a capital accumulation plan (CAP) retirement plan implemented in a non-profit institution. At 701, a set of members of a non-profit institution are identified. At 703, a deferred compensation amount intended for each of the set of members is extracted. At 705, a first portion of the deferred compensation is used to purchase a term life universal life insurance policy for each of the members. At 707, a second portion of the deferred compensation is routed to one or more interest bearing investment vehicles. At 709, future benefits are disbursed to the members, wherein the disbursement is taken from the second portion of the deferred compensation invested into the investment vehicle(s).

Process flow 700 of FIG. 7 illustrates the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, CAP tool 120 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc. by a service provider that offers to deploy or integrate computing infrastructure with respect to a process for code testing and correcting non-compliant source code in an IDE. Thus, embodiments herein disclose a process for supporting computer infrastructure, comprising integrating, hosting, maintaining and deploying computer-readable code into a computing system (e.g., computer system 104), wherein the code in combination with the computing system is capable of performing the functions described herein.

In another embodiment, the invention provides a method that performs the process steps of the invention on a subscription, advertising and/or fee basis. That is, a service provider, such as a Solution Integrator, can offer to create, maintain, support, etc., a process for structuring a capital accumulation plan (CAP) retirement plan implemented in a non-profit institution. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may also be a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

It is apparent that there has been provided approaches for structuring a capital accumulation plan (CAP) retirement plan implemented in a non-profit institution. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for providing a capital accumulation plan (CAP) retirement plan implemented in a non-profit institution, the method comprising:
identifying, by a computing device, a set of members of the non-profit institution;
extracting, by the computing device, a deferred compensation amount intended for each of the set of members;
using a first portion of the deferred compensation amount intended for each of the set of members to purchase a term life universal life insurance policy for each of the set of members;
routing, by the computing device, a second portion of the deferred compensation amount intended for each of the set of executives members to one or more interest bearing investment vehicles;
disbursing, by the computing device, future benefits to the set of members, the disbursement taken from the second portion of the deferred compensation invested into the one or more interest bearing investment vehicles.

2. The method of claim 1, wherein the non-profit institution is an owner and a beneficiary of the term life universal life insurance policy for each of the set of executives.

3. The method of claim 1, further comprising disbursing, by the computing device, an additional compensation amount to one or more of the set of executives, the disbursement taken from the second portion of the deferred compensation invested into the one or more interest bearing investment vehicles.

4. The method according to claim 1, wherein the deferred compensation amount is pre-tax compensation.

5. The method according to claim 1, wherein the future benefits disbursed to the set of executives comprises one or more of the following: a tax free retirement benefit, a tax free death benefit, and a tax free disability benefit.

6. The method according to claim 1, further comprising routing, by the computing device, upon a death of one of the set of members, a payout amount from the term life universal life insurance policy corresponding to the deceased one of the set of members, to the one or more interest bearing investment vehicles.

7. The method according to claim 1, the non-profit institution comprising a non-profit hospital.

8. The method according to claim 1, wherein the deferred compensation amount is selected by each of the set of members, and wherein the deferred compensation amount is unlimited as allowed by section 457(f) of the Internal Revenue Service (IRS) code.

9. The method according to claim 1, further comprising providing, by the computing device, a survivorship benefit to a beneficiary of a deceased executive from the set of executives who dies before electing retirement benefits.

10. A system for providing a capital accumulation plan (CAP) retirement plan implemented in a non-profit institution, comprising:
a memory medium comprising program instructions;
a bus coupled to the memory medium; and
a processor, for executing the program instructions, coupled to a CAP tool via the bus that when executing the program instructions causes the system to:
identify a set of members of the non-profit institution;
extract a deferred compensation amount intended for each of the set of members, the deferred compensation amount being pre-tax compensation;
use a first portion of the deferred compensation amount intended for each of the set of members to purchase a term life universal life insurance policy for each of the set of members;
route a second portion of the deferred compensation amount intended for each of the set of executives members to one or more interest bearing investment vehicles;
disburse future benefits to the set of members, the disbursement taken from the second portion of the deferred compensation invested into the one or more interest bearing investment vehicles.

11. The system of claim 10, wherein the non-profit institution is an owner and a beneficiary of the term life universal life insurance policy for each of the set of executives.

12. The system of claim 10, the program instructions further causing the system to disburse an additional compensation amount to one or more of the set of executives, the disbursement taken from the second portion of the deferred compensation invested into the one or more interest bearing investment vehicles.

13. The system according to claim 10, wherein the future benefits disbursed to the set of executives comprises one or more of the following: a tax free retirement benefit, a tax free death benefit, and a tax free disability benefit.

14. The system according to claim 10, the program instructions further causing the system to route, upon a death of one of the set of members, a payout amount from the term life universal life insurance policy corresponding to the deceased one of the set of members, to the one or more interest bearing investment vehicles.

15. The system according to claim 10, the non-profit institution comprising a non-profit hospital.

16. The system according to claim 10, wherein the deferred compensation amount is selected by each of the set of members, and wherein the deferred compensation amount is unlimited as allowed by section 457(f) of the Internal Revenue Service (IRS) code.

17. The system according to claim 10, the program instructions further causing the system to provide a survivorship benefit to a beneficiary of a deceased executive from the set of executives who dies before electing retirement benefits.

18. A computer program product for providing a capital accumulation plan (CAP) retirement plan implemented in a non-profit institution, the computer program product comprising a computer readable storage device, and program instructions stored on the computer readable storage device, to:
identify a set of members of the non-profit institution;
extract a deferred compensation amount intended for each of the set of members, the deferred compensation amount being pre-tax compensation;
use a first portion of the deferred compensation amount intended for each of the set of members to purchase a term life universal life insurance policy for each of the set of members;
route a second portion of the deferred compensation amount intended for each of the set of executives members to one or more interest bearing investment vehicles;
disburse future benefits to the set of members, the disbursement taken from the second portion of the deferred compensation invested into the one or more interest bearing investment vehicles.

19. The computer program product of claim 18, wherein the non-profit institution is an owner and a beneficiary of the term life universal life insurance policy for each of the set of executives.

20. The computer program product of claim 18, further comprising program instructions to disburse an additional compensation amount to one or more of the set of executives, the disbursement taken from the second portion of the deferred compensation invested into the one or more interest bearing investment vehicles.
